(19) United States
(12) Patent Application Publication
(10) Pub. No.: US 2016/0161324 A1
(43) Pub. Date: Jun. 9, 2016

(54) Load Pressure Monitoring Device

(71) Applicant: Plastoform Industries Limited, Hong Kong (CN)

(72) Inventor: Kin Man TSE, Hong Kong (CN)

(21) Appl. No.: 14/561,161

(22) Filed: Dec. 4, 2014

(51) Int. Cl. G01G 19/52; G01G 19/14

(52) U.S. Cl. CPC G01G 19/52; G01G 19/14

(57) ABSTRACT

A load pressure monitoring and transmission device and method thereof. Particularly, the application provides a load pressure monitoring and transmission device for a luggage carrying bag such as backpack which is characterized by monitoring load pressure on the backpack and transmitting said monitored load pressure on the backpack on a user's mobile communication device. More particularly, the application provides a load pressure monitoring and transmission device for a backpack comprising a weight sensor; a motion sensor; a data recording device; and a transmission device.

### FIELD OF THE INVENTION

The present application generally relates to the field of load pressure monitoring and transmission. Particularly, the application provides a load pressure monitoring and transmission device and method thereof.

### BACKGROUND

Modern luggage carrying bag, such as backpacks have revolutionized the way people carry their luggage while they are on the move. A backpack may have several different applications for a variety of users, such as for travelers, school kids etc. In spite of serving a wide consumer base for various applications, back pack sometimes could create health problems to the backpack users such as shoulder, back pain or undesirable stress to limbs. Eventually, such pain may convert into severe chronic problems. In most of the cases such health problems occur due to carrying a quantity much larger than what a normal human body can carry using backpack.

Prior art literature illustrates a variety of method, system, and general purpose device for determining weight of any such luggage carrying bag such as backpack and decide whether a user can carry such weights or not. However, most of such devices, for example weighing scale could access weight of any luggage carrying bag such as backpack at a given point of time only. The existing devices fail to determine, evaluate and record real time weight of a luggage carrying bag such as backpack, while the user is carrying said luggage carrying bag such as backpack on the move. Most of the existing method, system, and general purpose device fail to measure determine and communicate the carrying weight in real time and the load pressure created by said weight on the user.

Thus, in the light of the above mentioned background art, it is evident that, there is a need for a device and method thereof for load pressure monitoring of a luggage carrying bag such as backpack on the user. There is also a need for a device and method thereof which could transmit and communicate to the user the monitored load pressure created by the luggage carrying bag such as backpack weight, wherein the user can take corrective actions to avoid any potential health problem which might arise out of such load pressure. A load pressure monitoring and transmission device and method thereof is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a load pressure monitoring and transmission device and method thereof.

In an embodiment of the present invention, a load pressure monitoring and transmission device (100) is provided for a luggage carrying bag such as backpack (200). The load pressure monitoring and transmission device (100) is characterized by monitoring load pressure on the luggage carrying bag such as backpack (200) and transmitting said monitored load pressure on the backpack (200) on a user's mobile communication device (300). The load pressure monitoring and transmission device (100) for the backpack (200) comprises of a weight sensor (102) for measuring weight of the backpack (200); a motion sensor (104) for detecting motion of the backpack (200); a data recording device (106) for recording weight sensor data and motion sensor data; and a transmission device (108) for transmitting the recorded weight sensor data and motion sensor data to the user's mobile communication device (300).

In another embodiment of the present invention, a method is provided for monitoring and transmitting load pressure on a luggage carrying bag such as backpack (200) using a load pressure monitoring and transmission device (100). The method for monitoring and transmitting load pressure on the backpack (200) comprises processor implemented steps of measuring weight of the backpack (200) using a weight sensor (102); detecting motion of the backpack (200) using a motion sensor (104); recording weight sensor data and motion sensor data using a data recording device (106); transmitting the recorded weight sensor data and motion sensor data to the user's mobile communication device (300) using a transmission device (108); and receiving recorded weight sensor data and motion sensor data on mobile communication device (300) for determining load pressure on the backpack (200).

The above mentioned device and method thereof is provided for load pressure monitoring and transmission but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a block diagram illustrating system architecture for a load pressure monitoring and transmission device.

FIG. 2: shows a view illustrating a load pressure monitoring and transmission device affixed at the bottom of the backpack.

FIG. 3: shows multiple views illustrating a load pressure monitoring and transmission device affixed at both straps of the backpack in a padded enclosure.

FIG. 4: shows multiple views illustrating a load pressure monitoring and transmission device affixed at both straps of the backpack with a tension sensor.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

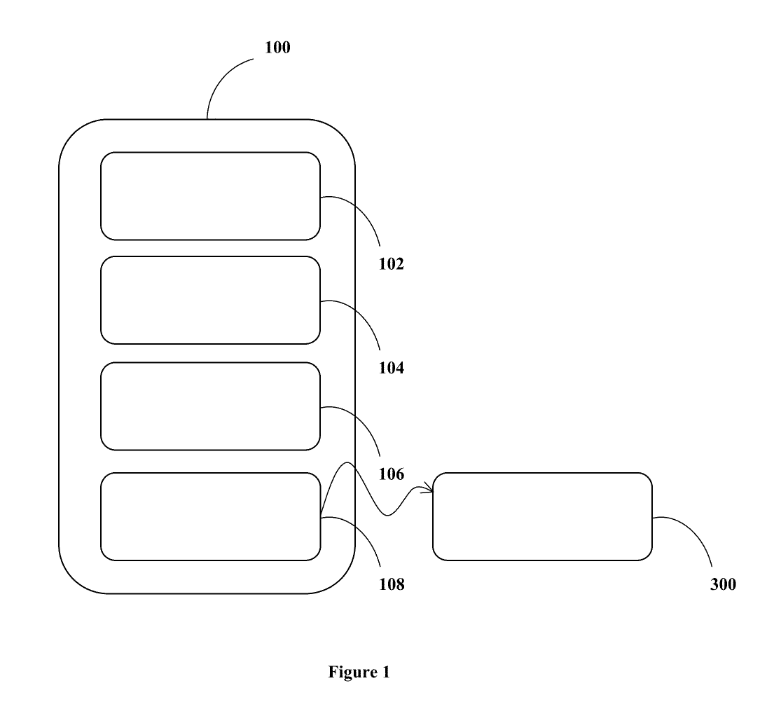

Referring to FIG. 1 is a block diagram illustrating system architecture for a load pressure monitoring and transmission device.

In an embodiment of the present invention, a load pressure monitoring and transmission device (100) for a luggage carrying bag is provided. The luggage carrying bag is selected from a group comprising but not limited to a backpack (200), luggage trolley, any wheeled luggage carrier, and light-steel device for carrying baby.

In an embodiment of the present invention, a load pressure monitoring and transmission device (100) for the backpack (200) is provided. The load pressure monitoring and transmission device (100) is characterized by monitoring load pressure on the backpack (200) and transmitting said monitored load pressure on the backpack (200) on a user's mobile communication device (300). The load pressure monitoring and transmission device (100) for the backpack (200) comprises of a weight sensor (102) for measuring weight of the backpack (200); a motion sensor (104) for detecting motion of the backpack (200); a data recording device (106) for recording weight sensor data and motion sensor data; and a transmission device (108) for transmitting the recorded weight sensor data and motion sensor data to the user's mobile communication device (300).

In an embodiment of the present invention, the weight sensor (102) for measuring weight of the luggage carrying bag such as backpack (200) determines load pressure on the backpack (200) when the motion sensor (104) detects the motion of the backpack (200). The user is enabled to set a maximum threshold load pressure on the backpack (200) using the mobile communication device (300).

In an embodiment of the present invention, the transmission device (108) for transmitting the recorded weight sensor data and motion sensor data to the user's mobile communication device (300), is connected with mobile communication device (300) using a communication protocol selected from a group comprising of Bluetooth, Bluetooth Low Energy and Wi-Fi. The user's mobile communication device (300) is selected from a group comprising of a mobile phone, a laptop, a tablet and a PDA.

In an embodiment of the present invention, the mobile communication device (300) is adapted for receiving recorded weight sensor data and motion sensor data for determining load pressure on the luggage carrying bag such as backpack (200).

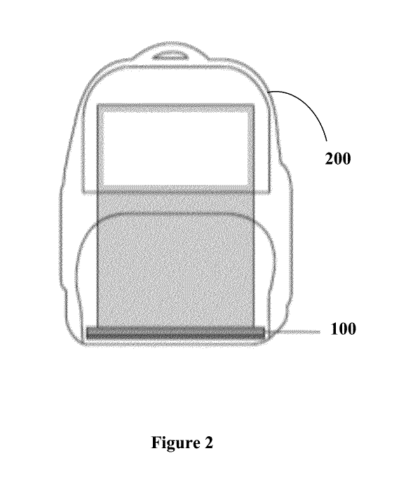

Referring to FIG. 2 is a view illustrating a load pressure monitoring and transmission device affixed at the bottom of the backpack.

In another embodiment of the present invention, the load pressure monitoring and transmission device (100) for the luggage carrying bag such as backpack (200) is adjustably affixed at the bottom of the backpack (200). The load pressure monitoring and transmission device (100) for the backpack (200) adjustably affixed at the bottom of the backpack (200) is of a dimension of 230 mm of length by 76 mm of width. In order to fit the load pressure monitoring and transmission device (100) for the different size of backpack (200), the edges of the load pressure monitoring and transmission device (100) may be adjusted to fix the position.

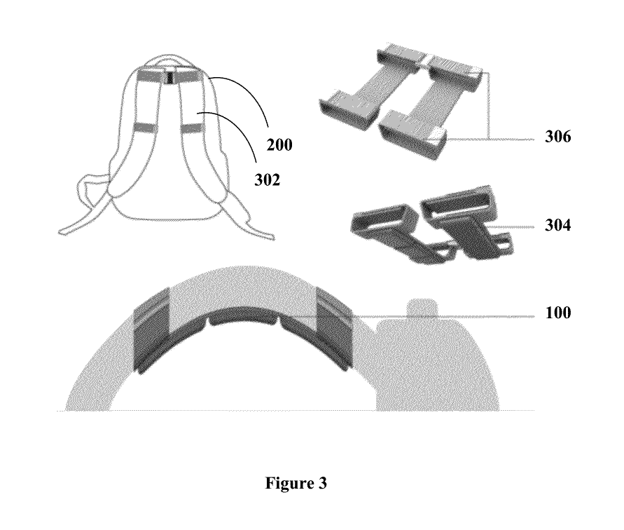

Referring to FIG. 3 is multiple views illustrating a load pressure monitoring and transmission device affixed at both straps of the backpack in a padded enclosure.

In an alternative embodiment of the present invention, the load pressure monitoring and transmission device (100) for the luggage carrying bag such as backpack (200) is affixed at both straps (302) of the backpack (200) in a padded enclosure (304) with the help of a pair of hook and loop fastener (306).

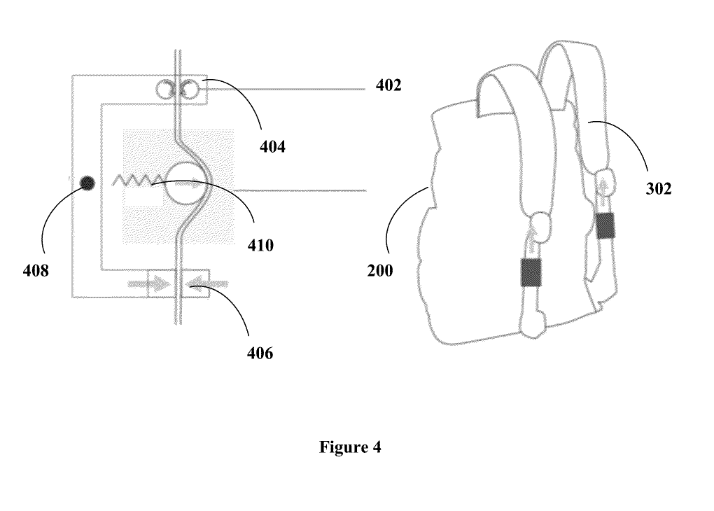

Referring to FIG. 4 is multiple views illustrating a load pressure monitoring and transmission device affixed at both straps of the backpack with a tension sensor.

In an alternative embodiment of the present invention, the load pressure monitoring and transmission device (100) for the luggage carrying bag such as backpack (200) is affixed at both straps (302) of the backpack (200), with a pair of unidirectional moving roller (402) at one end (404) of the both straps (302) and fixed at the other end (406) of the both straps (302) of the backpack (200) for producing a difference of tension created by increased weight of the backpack (200), which is measurable with the help of a tension sensor (408) adapted for sensing the difference of tension by a spring (410) attached to the tension sensor (408).

In another embodiment of the present invention, a method for monitoring and transmitting load pressure on a luggage carrying bag such as backpack (200) using a load pressure monitoring and transmission device (100) is provided. The method for monitoring and transmitting load pressure on a backpack (200) using a load pressure monitoring and transmission device (100) is comprises processor implemented steps of measuring weight of the backpack (200) using a weight sensor (102); detecting motion of the backpack (200) using a motion sensor (104); recording weight sensor data and motion sensor data using a data recording device (106); transmitting the recorded weight sensor data and motion sensor data to the user's mobile communication device (300) using a transmission device (108); and receiving recorded weight sensor data and motion sensor data on mobile communication device (300) for determining load pressure on the backpack (200).

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1. A load pressure monitoring and transmission device (100) for a luggage carrying bag; said load pressure monitoring and transmission device (100) is characterized by monitoring load pressure on the luggage carrying bag and transmitting said monitored load pressure on the luggage carrying bag on a user's mobile communication device (300); said load pressure monitoring and transmission device (100) for the luggage carrying bag comprises of:
a. a weight sensor (102) for measuring weight of the luggage carrying bag;
b. a motion sensor (104) for detecting motion of the luggage carrying bag;
c. a data recording device (106) for recording weight sensor data and motion sensor data; and
d. a transmission device (108) for transmitting the recorded weight sensor data and motion sensor data to the user's mobile communication device (300).

2. The load pressure monitoring and transmission device (100) for the luggage carrying bag as claimed in claim 1, wherein the weight sensor (102) for measuring weight of the backpack (200) determines load pressure on the luggage carrying bag when the motion sensor (104) detects the motion of the luggage carrying bag.

3. The load pressure monitoring and transmission device (100) for the luggage carrying bag as claimed in claim 1, wherein the mobile communication device (300) is adapted for receiving recorded weight sensor data and motion sensor data for determining load pressure on the luggage carrying bag.

4. The load pressure monitoring and transmission device (100) for the luggage carrying bag as claimed in claim 1, wherein the load pressure monitoring and transmission device (100) for the luggage carrying bag is adjustably affixed at the bottom of the luggage carrying bag.

5. The load pressure monitoring and transmission device (100) for the luggage carrying bag as claimed in claim 1, wherein the load pressure monitoring and transmission device (100) for the luggage carrying bag is affixed at both straps (302) of the luggage carrying bag in a padded enclosure (304) with the help of a pair of hook and loop fastener (306).

6. The load pressure monitoring and transmission device (100) for the luggage carrying bag as claimed in claim 1, wherein the load pressure monitoring and transmission device (100) for the luggage carrying bag is affixed at both straps (302) of the luggage carrying bag, with a pair of unidirectional moving roller (402) at one end (404) of the both straps (302) and fixed at the other end (406) of the both straps (302) of the luggage carrying bag for producing a difference of tension created by increased weight of the luggage carrying bag, which is measurable with the help of a tension sensor (408) adapted for sensing the difference of tension by a spring (410) attached to the tension sensor (408).

7. The load pressure monitoring and transmission device (100) for the luggage carrying bag as claimed in claim 1, wherein the transmission device (108) for transmitting the recorded weight sensor data and motion sensor data to the user's mobile communication device (300), is connected with mobile communication device (300) using a communication protocol selected from a group comprising of Bluetooth, Bluetooth Low Energy and Wi-Fi.

8. The load pressure monitoring and transmission device (100) for the luggage carrying bag as claimed in claim 1, wherein the user is enabled to set a maximum threshold load pressure on the luggage carrying bag using the mobile communication device (300).

9. The load pressure monitoring and transmission device (100) for the luggage carrying bag as claimed in claim 1, wherein the user's mobile communication device (300) is selected from a group comprising of a mobile phone, a laptop, a tablet and a PDA.

10. A method for monitoring and transmitting load pressure on a luggage carrying bag using a load pressure monitoring and transmission device (100); said method comprises processor implemented steps of:
a. measuring weight of the luggage carrying bag using a weight sensor (102);
b. detecting motion of the luggage carrying bag using a motion sensor (104);
c. recording weight sensor data and motion sensor data using a data recording device (106);
d. transmitting the recorded weight sensor data and motion sensor data to the user's mobile communication device (300) using a transmission device (108); and
e. receiving recorded weight sensor data and motion sensor data on mobile communication device (300) for determining load pressure on the luggage carrying bag.
